(19) United States
(12) Patent Application Publication
(10) Pub. No.: US 2015/0108758 A1
(43) Pub. Date: Apr. 23, 2015

(54) TURBINE SYSTEM AND METHOD CONSTRUCTED FOR EFFICIENT LOW FLUID FLOW RATE OPERATION

(71) Applicants: Thomas W. Oakes, La Mesa, CA (US); Robert E. Oakes, El Cajon, CA (US)

(72) Inventors: Thomas W. Oakes, La Mesa, CA (US); Robert E. Oakes, El Cajon, CA (US)

(21) Appl. No.: 14/061,581

(22) Filed: Oct. 23, 2013

(51) Int. Cl. F03D 3/04; F03B 13/10; F03D 9/00

(52) U.S. Cl. CPC F03D 3/0427; F03D 9/002; F03B 13/10
USPC 290/52; 290/55

(57) ABSTRACT

Briefly, an efficient turbine is disclosed for converting kinetic fluid energy into a usable form, such as electricity. The turbine generation system has a turbine within a casing, with box-like catchers positioned in the turbine to efficiently capture the fluid, such as wind, and extract its energy, and direct the fluid to an exhaust. A compressive intake and channelizers cooperate to concentrate and direct the fluid into the boxes.

### RELATED APPLICATIONS

This application is related to U.S. patent application Ser. No. 11/612,613, filed Dec. 19, 2006, and entitled “System and Method for Generating Hydrogen Gas.”

### FIELD OF THE INVENTION

The field of the present invention is mechanical fluid turbine systems, including turbines for capturing wind energy using a mechanical catching, concentration, and energy extraction system. More particularly, the present invention relates to harvesting of renewable sources of environmentally available kinetic and radiation energy employing low wind, wind, small stream hydroelectric, and wave action. Accompanying driving principles of energy generation include concentration, channeling, energy source chaos reduction, internal capture and control, and a Venturi system to enhance captured energy flow from the system. The organized systems and methods produce leverage to generate electricity employing one or more rotary generation,

Background of the Invention

The availability of inexpensive supplies of carbon-based fuels enabled the United States to develop a dynamic and vibrant national economy through most of the twentieth century. Today, even though U.S. sources of high-quality fossil fuel feedstocks are mostly exhausted, 85 percent of U.S. energy comes from fossil fuels. To meet the demand for these fuels, the United States imports more and more fuel. Today 61 percent of our petroleum and 17 percent of our natural gas are imported.

The current trend to high prices of petroleum and natural gas is not likely to change, as reserves are limited and demand is increasing. Known reserves of petroleum and natural gas are projected to last no more than 25 years and 45 years, respectively, if consumed at the rate projected for a growing global economy (Source: U.S. Energy Information Administration (EIA) 2007 http://www.eia.doe.gov). Others (President Obama's speech Mar. 29, 2012 in Las Vegas) indicate that there is fewer than 100 years of oil reserves available in the United States along with Newt Gingrich, candidate for President, saying on March 15, 2012 that there are in ground reserves for 125 years of natural gas. One hundred years of society is not a very long time. In view of certain recent increased supplies of natural gas in the United States increasing its use to generate energy only increases the CO2 and other pollutants put into the atmosphere and the lands we all use. Employing more efficient renewables and sustainable energy technologies such as described here provides an improved environment. Thus, it is evident that there is a tremendous need for on-site generated renewable energy harvested from environmental sources such as is described in the unobvious and novel designs in this patent.

Electrical generation by wind has been primarily carried out by large utilities and/or companies setting up large wind turbines in usually remote high wind mountain areas. The major electricity generation methods used today are based on consuming coal, oil, or natural gas to fire large steam turbines. Often long transmission lines are required over great distance and at high cost and loss of energy. Hoover Dam is an example of a hydroelectric energy source that is located a long distance from major populations. Nuclear plants are generally located some distance from the uses and require long distance transmission power lines to transport the electricity to users and are subject to decommissioning, dismantling, and low-level waste disposal problems.

The need for low wind electric generators is evident, wherein nearly all large wind bladed, 8′ and larger, generators do not start turning until approximately 18 mile per hour wind comes up (#4 on the Beaufort Code). The design of the present low wind generators are expected to begin turning on the Beaufort Code, at #2 which is 4-7 miles per hour, or 6-11 kilometers per hour and which is described as a light breeze where leaves rustle, wind can be felt, and wind vanes move. Many places in the United States have regular low wind such as ocean shores, lake shores, and low lying foot hills. Where the vast majority of people reside there is often low wind rather than high wind that is required by supper sized wind generators. An example is seen where 20 miles inland from the ocean shore the daily weather report on air speed is usually 5 to 10 miles per hour wind.

Nearly all wind turbines at the utility level and the smaller individual type employ three rotating blades or there are certain methods using rotating towers and/or vertical circular shapes that may not be acceptable by property covenant in some commercial, industrial, and residential areas. However, no practical way is known to generate electricity on-site where the energy is need, exclusively from the available renewable environmental energy sources, for individual and commercial needs, employing typically available low wind, employing no open turning blades or high obtrusive towers with vertical rotation. The present invention is planned for application in populated areas where code and public acceptance in urban, rural, and remote locations where there is prohibition of obtrusive noisy rotating large or small propeller blades. In some cases those open rotating blades may even be restricted by local codes and building ordinances.

The National Laboratory at ARCO Idaho made a nationwide study of the small streams in the United States. There are many more such streams than a casual review might identify and people have a great preference to locate their residence and vacation homes on these streams and have an accompanying need for electricity. In August 2010 the Natural Resources Water and Power Subcommittee of the U.S. House of Representatives introduced the Small-Scale Hydropower Enhancement Act (H.R. 5922) to promote efforts to produce more hydropower from smaller sources. Often utility electricity is not available in many of these locations; therefore the need for on-site small stream electricity has wide-spread appeal. These government actions help establish the need and economic growth possibilities for an invention such as is proposed here.

### DESCRIPTION OF THE PRIOR ART

Gagnon, U.S. patent application No. 61/245,461, does attempt to use a funneling effect, but still employs propeller blades that cannot take advantage of the increased air flow. The air is actually directed off the blades by the convex shape and rounded edges of the traditional propeller blades, reducing the power effect of the incoming wind. This system does not include a venturi effect for exiting air.

Lodewyk, U.S. Pat. No. 4,045,144, shows a wind concentrator. However it is a very open system not allowing for any building of the pressure of the incoming air.

U.S. Pat. No. 6,887,031 shows concentration through a series of circular fan blades, one set of blades feeding the air to the next, but it is also a very open system with convex propeller blades and no funneling effect of incoming air, nor any means to keep the incoming air in the path of the blades.

T. J. van der Horn, U.S. Pat. No. 6,713,893, uses two fan blades rotating in opposite directions. The blades are typical convex design with little ability to catch wind and with the opposite direction rotation very likely reduces generation capability in low wind.

Tocher, U.S. Pat. No. 6,887,031, uses concentrator wings that reportedly draw wind into the front of centralized concentric wings providing wind to the turbine impeller blades that are smaller than popular designs. The impeller blades are propeller shape with a convex and rounded edge design that allows the air to easily slide off the blade, rather than pushing on them.

Vertical axis wind turbines show no concentration or wind capturing devices while they may include concave shapes, but are open on the sides and ends, which allow sloughing off of the air moving. Attey, U.S. patent application Ser. No. 12/478,597, proposes catching wind interior to a vertical axis rotation, but the catchers are rounded and there is no way to keep the air interior, and the air can slip off the arms, because there are only three where space is open between the rounded sections. There is nothing to keep the air interior to the vertical unit.

### SUMMARY

An efficient turbine is disclosed for converting kinetic fluid energy into a usable form, such as electricity. The turbine generation system has a turbine within a casing, with box-like catchers positioned in the turbine to efficiently capture the fluid, extract its energy, and direct the fluid to an exhaust. A compressive intake and channelizers cooperate to concentrate and direct the fluid into the boxes. A second compressive intake is also connected with the exhaust, and includes a Venturi structure that increases the velocity of the exhaust fluid, thereby assisting in the efficient exhausting of the fluid from the turbine or concentration and pressurized boxes of the present system.

There is a widespread movement and interest by individuals, commercial, and government and military preference for renewable environmentally harvested energy in view of the energy raw materials shortages and high prices for user and for utility energy throughout the country. The present disclosure provides a distinct combination and application of three aspects of environmentally available kinetic and radiation energy. An aspect of the present invention provides widespread environmentally available low wind harvesting generator system employing a case with unique collectors, concentrators, fluid pressure capturing boxes, and a rotating shaft connected to an electrical turbine generator. Attached to the shaft are a series of members that catch incoming environmental fluid kinetic energy and concentrate and channel that captured energy to drive and rotate the shaft to turn an electrical turbine. A weatherized case is provided to handle environmental fluid flow conditions for harvesting the natural energy sources available.

A major aspect of one embodiment the present invention provides a kinetic energy flow capturing turbine generator system with an exterior funnel that directs, concentrates, and channelizes the in-coming random air movement into the case. This acts to pressurize the available energy that is focused, funneled, and channelized into the unique square boxes that capture the uniquely funneled and channelized environmental energy, which boxes are attached to the drive shaft and consequently to the electrical turbine in the electrical generating engine. This capturing and directing system overcomes the usual random, wobbling, and slipping of fluid flows that nature generally provides on rotating propeller blades. Incoming flows from nature are always mixed, random, and flocculating and they twist, turn, and shift in the forceful movements they have. Very seldom will wind, stream, or steam flows present a flat front face against any obstacle.

An important novel feature of this application is the Venturi air system that draws the kinetic energy flow out of the case, so used energy in the boxes will not block the incoming pressure of the fresh incoming fluid. This basic Venturi system provides fluid flow to the turbine generator system in which the concentrated and channelized energy flow enters and passes through the case with a Venturi as part of the energy exit system providing an increase in flow or a drawing of the flow by means of a lower pressure area acting to pull the fluid stream out of the case. This Venturi construction of a section of the flow exit system has large concentrating openings at the beginning of the case ends with a constricted section of the Venturi in the middle creating suction and/or vacuum for pulling the exiting flow and thus providing additional pull on the kinetic energy loaded box system attached to the drive shaft of the electrical turbine.

This renewable energy harvesting and storage system is designed to capture widely available natural fluid energy sources including low wind, and small stream hydro. By capturing these natural and renewable energy sources in this novel system these energy sources can be converted to electrical energy and employed to generate storable hydrogen, an energy carrier, which can then be used as needed in fuel cells for electricity, for heating and cooling in commercial, industrial and government and military applications as well as for fueling automobiles and other transportation engines.

A major aspect of one embodiment of the present invention provides a kinetic energy turbine generator system that has box-like attachments on the arms of the rotating shaft to keep the kinetic energy that moves into the box-like attachments so the moving energy is captured and changed from a chaotic movement to controlled energy in the smaller individual boxes, rather than being able to freely move from side to side or up and down. This system of closely attached boxes open on the outer face and individually constitute a square with a flat bottom with sides higher than the base width. This system of boxes with open faces, when facing the channelized rectangle opening of the fluid intake, will fill the entire opening as the individual sets of boxes rotate on the central shaft. This feature keeps the wind and fluid pressure in the box-like catchers, rather than allowing the moving fluid to fall off, to mix, spread, and weaken as air can do on all traditional fan blades, thus keeping the energy pressure in the boxes attached to the arms of the rotating system. The box-like wind catcher attachments provide greater pressure to the rotation wheel arms and consequently on the drive shaft rather than those employing traditional propeller convex blades or even rounded-bottom cup-like attachments. Without the square wind catching boxes on the arms, incoming energy can flow and mix with other chaotic movement, which thus has a less forceful push on the arms and drive shaft and on into the electrical turbine. In order to drive the natural forces with even more pressure upon the drive shaft and the electrical turbine the box catchers may also be treated with textured coatings containing both small and medium sized particles (1 or 2 cm up to 5 cm or as appropriate considering the box size) on the interior walls of the boxes.

An additional aspect of one embodiment of the present invention provides a wind turbine generator system designed to harvest low wind in the 2 to 15 mile per hour wind speed compared to other competing 8 to 12 foot and larger bladed turbines that do not start turning until 15 to 18 MPH or higher wind. To operate with low wind this novel and unobvious systems of wind concentration, channelizing, and unique box-like designs with accompanying Venturi suction of exiting air, all help to keep control of the available chaotic wind and other fluid flows rather than have such flatten out on convex propeller blades and disappear in unwanted directions. A shroud is also included to contain the air where it is wanted with exit ports to allow it to be sucked out in the proper place in the Venturi fluid movement cycle. There is also a transmission or gear system to match the wind velocity with the electrical turbine to take advantage of low wind in many locations where people live and work.

The intake boxes on the arms of the drive shaft are attached directionally to produce a starting motion from even very low intake kinetic fluid movement. This attachment of the boxes provides direction and starting leverage to the boxes, where without this there could be a non-directional push on the boxes.

It is anticipated that this energy system can be constructed with moderately low cost materials that are readily available. The case can be sheet metal or thermoformed of plastic sheets; the wind catcher boxes can be assembled out of plastic or metal sheets or inexpensively thermoformed of plastic. The front concentrator set may be made of metal or plastic, as can the fluid exit Venturi.

A major embodiment of the present invention is an energy exit Venturi, which construction, creates a higher pressure and a low velocity prior to the exiting air intake ports followed by a physically smaller air flow area that functions to create a lower pressure than in the front section of the Venturi with an accompanying higher exit air flow out the exit port yielding a suction process drawing exiting air from the fluid turbine case, because of the lower pressure in that section of the Venturi. This reduces possible back pressure on the box-like energy catchers on the rotating shaft and is designed to add vacuum suction that will pull on the box-like wind catchers, increasing turning pressure on the shaft. This fluid moving process operates on Daniel Bernoulli's principle which states that, where the velocity is high, pressure is low, and where the velocity is low, the pressure is high, increasing air movement in the channel.

This Venturi system draws on the pressurized flow being released from the boxes on the arms of the shaft at an approximate position of half way around inside the case. At this position the Venturi principal activates to suck air out of the boxes and the case passageway and thus is removing any drag that would otherwise be on the loaded push on the catcher boxes. This will increase pressure on the arms of the rotating shaft.

The Venturi system is powered by an opening on the front of the case allowing kinetic flow to pass from the front to the rear of the case, and making a drawing effect on the air in the case to get air out of the case, increasing the continual fluid stream through the case. This Venturi system has flanges extending outside the case to gather and harvest additional kinetic energy and pressurize it into the Venturi opening, thus to increase the overall Venturi effect.

### BRIEF DESCRIPTION OF THE DRAWINGS

FIG. 1 is a side view cut-away diagram of the low wind turbine generation system and method in accordance with the present invention.

FIG. 2 is a front view cut-away of the low wind turbine generation system and method in accordance with the present invention.

FIG. 3 is a perspective view of the low wind electrical generating system and method in accordance with the present invention.

FIG. 4a is a front view of propeller blades for a low wind generator in accordance with the present invention. Each blade of the propeller is illustrated with attached wind catching boxes.

FIG. 4b is a side view of a low wind generator in accordance with the present invention.

FIG. 4c is a side view of an individual catching box for attachment to a propeller blade of a low wind generator in accordance with the present invention.

### DESCRIPTION OF THE PREFERRED EMBODIMENTS

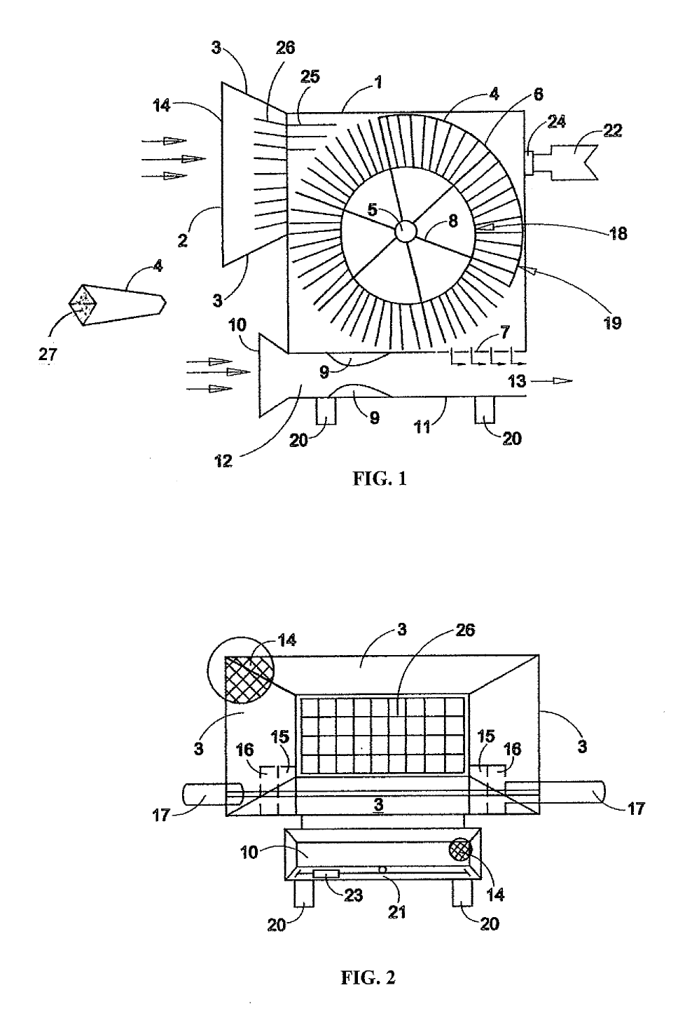

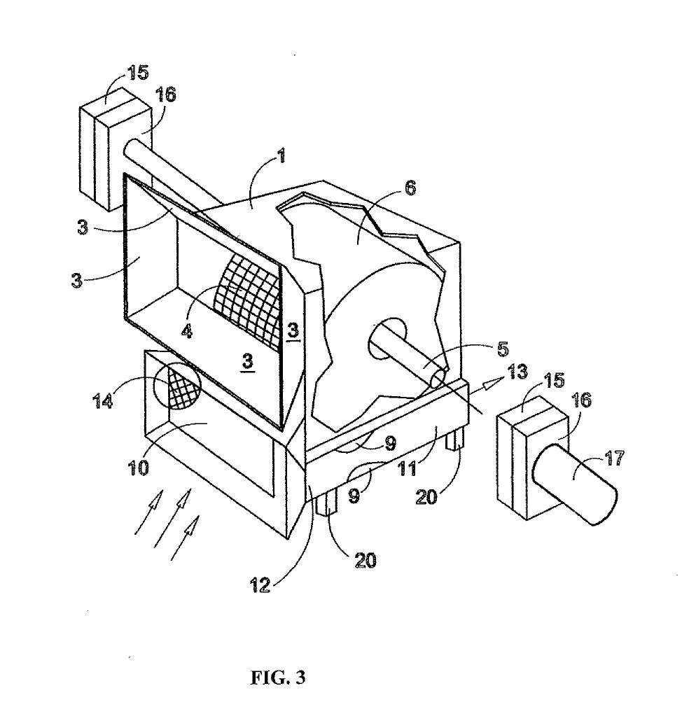

Referring to FIG. 1 and FIG. 2, a case 1 houses a turbine with rotating box 4 units attached to a shaft 5, the box units 4 accepting environmental fluid kinetic energy in the form of wind at intake 2 to activate gears and a transmission 15 to drive an electric generator 17 for generating electricity employing the kinetic energy of the wind. The new system is able to perform particularly effectively in relatively low wind conditions as compared to larger open bladed wind turbines with the traditional three large extended blades or other vertical designs and compared to fin based small hydroelectric generators. This electrical generation system has a kinetic energy intake 2, including extended flanges 3, that increase the open face wind collection area of the case, and consequently gathers more kinetic energy that is concentrated, directed, and funneled into the channelizing squares 25; thereby increasing the usable energy to drive the electrical turbine 17 and generate electricity.

The case 1 positions a shaft 5 extending across the case that carries the box fluid catchers 4 that are attached to separating disks and by connecting arms 8 to the shaft 5. The shaft drives the wind power to the gear box 16 and transmission 15 that controls and drives the electrical generating turbine 17. Although shown generally as rectangular blocks, it will be appreciated that the fluid catching boxes may take other geometric shapes 4. Further, the boxes 4 are illustrated being wider at the top and narrower at the bottom to facilitate orientation around the shaft 5. It will be understood that other shapes may be used.

In FIG. 1 there is a fixed shroud or housing 6 that circles part of the turning wind catchers 4 and arms 8 of the shaft. This shroud is placed to keep flow pressure in the area of the wind catcher boxes 4. Catcher boxes may have a texture coating inside 27. In addition there is an exit port 7 out of the shroud and Venturi case to provide exit flow 13 by the suction of the Venturi to aid in drawing the used energy out of the case.

FIG. 1 and FIG. 2 disclose the Venturi system 11. The Venturi 11 has a system of extending structures 9 built in that creates the Venturi effect. The Venturi flow intake 10 in the front of the case is exposed to the incoming wind, has flanges 3 to collect and concentrate additional flow over the amount of air flow the exact shape of the Venturi case would gather. In the first section of the Venturi 11, at the structures 9, the velocity is lowered and the pressure is higher than the incoming flow as compared to the intake 10. In the exit side 13 of the Venturi the velocity of the flow movement is higher and pressure is lower. This causes a lower pressure area that assists in pulling the exhaust wind out of the Venturi case 11 and exit through the exit 13.

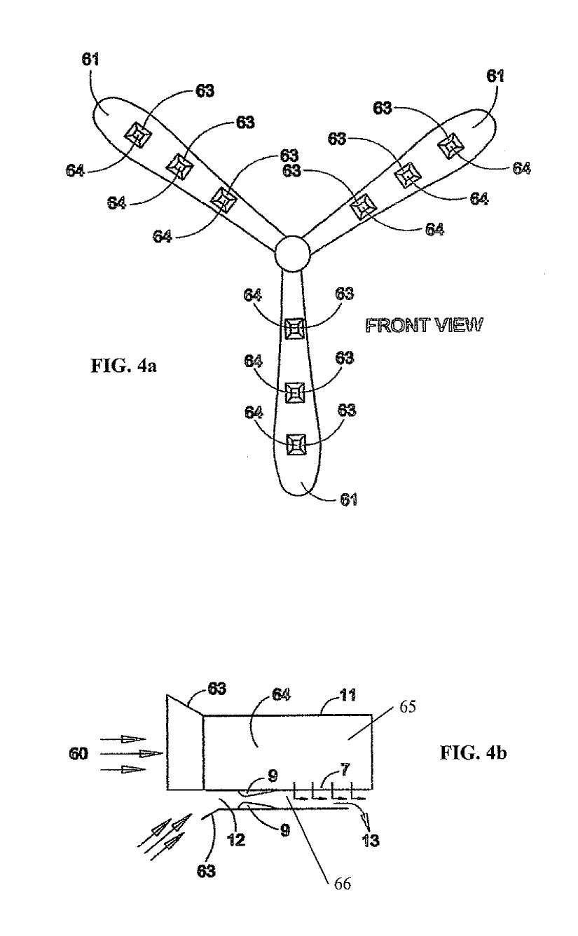

In FIG. 2 the forward facing extended flanges 3 are visible on all four sides of the entrance space 2 for funneling and concentrating the incoming environmental energy. These flanges 3 are in place to capture and harvest increased amounts of kinetic energy over what would enter the case without the extended flanges. In FIG. 2 note that a screen 14 is in place over the entire structure to prevent birds and other objects from entering the case. On the side of the case 1 is transmission case 15 that may include gear driven 16 ratio, both or either of which are in place to manage the power that is in the drive shaft 5 that drives the electrical generating turbine 17 in order to derive electricity from the available power of the incoming and processed kinetic energy. The case has a base system 20 for stabilizing the case to a foundation whether it is in an elevated position on a stand, a roof, or attached at ground level. In FIG. 2 there is a swivel system 21 and orientation apparatus 22 (in FIG. 1) to maintain the case 1 in a position for constant facing into the environmental energy source with accompanying brake 23 and air flow system 24 (in FIG. 1) that protects the case from possible damaging high winds. FIG. 3. shows a perspective view of the generator described with reference to FIG. 1 and FIG. 2. FIG. 3. does not illustrate the intake channelizers 25 (FIG. 1) to assist in understanding the relationship between the channelizers and the other turbine structures. One skilled in the art will readily recognize that the channelizers will extend across the entire opening. It will also be appreciated that other structures may be used to direct the driving wind from the concentrator portion through the channelizers to the wind-catching boxes. FIG. 3 also has a cut-away portion on the lower exhaust path that shows the Venturi structure discussed with reference to FIGS. 1 and 2. It will be understood that other shapes and placements for the Venturi structure may be used consistent with this disclosure. FIG. 3 shows the series of receiver boxes 4 facing out to receive incoming wind flow that are attached to the shaft 5.

In FIGS. 1, 2, & 3 one skilled in the art can visualize and understand that although the drawing depicts principles, device, and machines that lend themselves to the fluid flow processing wind the same principles apply to flowing water, and steam that can pass through the system making electricity with the same noted flow compression technologies and the same Venturi forces to help deplete and make the boxes ready for new income flows of the several fluids that flow through the electric generator.

The disclosed renewable energy system provides a method and system to provide concentrated, and channelized multiple sources from the available powerful environmental energy flows for application to fulfill human energy needs for residential, commercial, industry, government, and defense department that reduces the demand for fossil fuel such as wood, coal, oil, natural gas, biofuels, nuclear, and utility electricity, the latter of which mostly comes from fossil fuel. Harvesting available environmental energy of localized low wind and available small stream hydro energy, through concentration and channelizing to make electricity also provides opportunity to fill energy needs such as cooking, heating, air conditioning, furnaces, kilns, vehicles, etc. To take further advantage of this renewable energy method and system also provides the opportunity to produce clean hydrogen by splitting water with this source of electrical energy without the burden of fossil fuels and their expense of electrolyzers and disadvantages of deep well drilling and oil importing from the several foreign hostile nations. Hydrogen is clean and renewable and from the present application can be used to address all of the above noted human energy needs.

In accordance with the present disclosure, the fluid flow is managed by concentration, channeling, and small box containment to drive an electrical generating turbine using directed openings. There is an accompanying intake for a fluid flow powered Venturi opening with pressurized flow exit to aid in suction and pull on exiting flows through the system. Employment of the Venturi principle in this patent is novel and unobvious, separating this application from all other low flow wind and small stream patents.

There is an axle positioned in the enclosure with a set of members extending radially. A plurality of flow catching boxes are attached to the respective radial members. Major features of this application are the flow concentrators and channeling positioned to harvest stream flows through the opening that is positioned in such a manner that the concentrated flow is secondarily concentrated and is directed into the flow catching boxes. The funneling and concentration system on the front of the case provides 6 to 10 times the flow kinetic pressure into the enclosure as compared to no concentration and no channeling that other wind and small hydro generators offer.

In this scenario of incoming flow of low wind and small stream flow, all of which appear in random and chaotic conditions are captured and controlled and not allowed to act randomly or move around in the box-type wind catchers as compared to the slipping, sliding, and rolling off as on all other types of blades, propellers, and fans with their convex rounded surfaces. The multiple box catchers are open to all incoming concentrated flow, rather than operating as traditional three propeller or fan bladed generators. A gear and transmission system with accompanying computerized control is included to provide additive adjustments for varying flow speeds for turning the turbine.

[45] These combined designs including the leveraging of concentration and channeling with Venturi suction applied in low flow wind generators and small stream hydroelectric systems make it more feasible to harvest these lower energy values from renewable sources for on-site, remote, rural, and/or urban renewable electricity. This otherwise un-captured energy is useful for a wide range of energy markets in many clean energy applications such as general purpose electricity as well as for battery charging, hydrogen production, for residential, industrial, telecommunications, commercial, government, and defense department use.

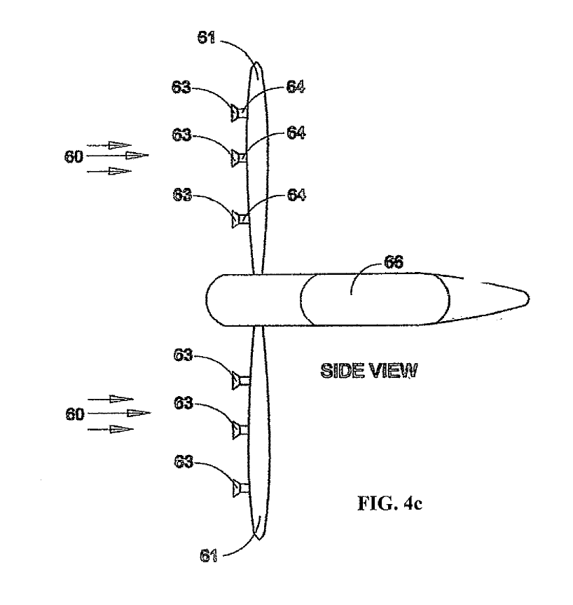

FIG. 4 illustrates another embodiment of the present invention. FIG. 4c has an electrical generating turbine 66 that has fan blades 61 that extend radially from the generator 66. The illustrated generator 66 has 3 blades, but more or fewer may be used. In use, the generator 66 is typically mounted on a pole or other elevated structure. The design and implementation of an electrical wind generator is well known, so will not be described in detail.

Advantageously, a set of capture boxes 64 are attached to each fan balde 61 to assist in the capture and conversion of wind 60 into electrical energy. As illustrated, the boxes 64 protrude above the surface of the blade 61, but it will be appreciated that the boxes may be integrally formed into the blade 61 itself. In one case, the externally projecting boxes would be useful for a retrofit application where the capture boxes 64 are attached to fans blades that are already built or installed.

Referring now to FIG. 4b, each capture box 64 has a concentrator 63 that captures and concentrates wind into the main cavity 65 of the capture box 64. The incoming air passes through the concentrator 63, into the main cavity 65, and exists through a cavity exit port 7. Each capture box 64 also has a lower channel 66 that accepts wind through a second concentrator flange 63. The wind received into the lower channel 66 passes through the Venturi structure 9, which causes a lower pressure area adjacent to the exit 13. This lower pressure area at the exit port 13 acts to draw air more efficiently from the main cavity 65 and out the exit port 13. Accordingly, more of the wind's energy may be captured and converted to electrical energy by the use of the Venture-aided capture boxes 64. It will be appreciated that the boxes may take many different shapes, sizes, placement, and density consistent with this disclosure. It will also be appreciated that the interior of the boxes many be coated or textured to enhance wind capture or to reduce friction.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed, is:

1. A turbine generating system, comprising:
a casing;
a turbine arranged to rotate on a drive shaft within the casing;
a set of boxes attached to the drive shaft and each arranged to have an opening facing radially outward toward an input port, the input port receiving an input fluid;
a compression fluid intake having a set of fluid channelizers that extend to the input port; and
a second fluid compression intake connected to a fluid exhaust, the second fluid intake constructed to generate a higher speed fluid velocity at a fluid exhaust port.

2. The turbine generating system according to claim 1, further including flanges attached to the input port and positioned to capture and direct the input fluid through the input port.

3. The turbine generating system according to claim 2, further including channelizers cooperating with the flanges and positioned to direct the input fluid through the input port.

4. The turbine generating system according to claim 3, wherein the channelizers are constructed to have an output port substantially equal to the size of each boxes opening, and the channelizers extend to, but do not contact, the boxes.

5. The turbine generating system according to claim 1, further including a shroud positioned adjacent to the rotating boxes from about the input port to the fluid exhaust, the shroud acting to retain the fluid in the boxes.

6. The turbine generating system according to claim 1, further comprising a Venturi structure in the second fluid compression intake for generating a lower pressure area adjacent the exhaust port.

7. The turbine generating system according to claim 6, further including flanges attached to the second fluid compression intake and positioned to capture and direct input fluid through the intake.

8. The turbine generating system according to claim 1, wherein the fluid is wind, water, or steam.

9. A water turbine generating system, comprising:
a casing;
a water turbine arranged to rotate on a drive shaft within the casing;
a set of water-catching boxes attached to the drive shaft and each arranged to have an opening facing axially outward toward an water input port, the water input port receiving a forceful flowing water;
a compression water intake having a set of water channelizers that extend to the water input port; and
a second water compression intake connected to an water exhaust, the second water intake constructed to generate a higher speed water velocity in the water exhaust.

10. The water turbine generating system according to claim 9, further including flanges attached to the water input port and positioned to capture and direct the forceful flowing water through the water input port.

11. The water turbine generating system according to claim 10, further including water channelizers cooperating with the flanges and positioned to direct the forceful flowing water through the water input port and into the water-catching boxes.

12. The water turbine generating system according to claim 9, further including a shroud positioned adjacent to the rotating water-catching boxes from about the water input port to the water exhaust, the shroud acting to retain the water in the boxes.

13. A wind turbine generating system, comprising:
a casing;
a wind turbine arranged to rotate on a drive shaft within the casing;
a set of wind-catching members attached to the drive shaft and each facing an air input port, the air input port receiving a driving wind;
a wind intake that extends to the air input port; and
a second wind intake connected to an air exhaust, the second wind intake constructed to generate a higher speed wind velocity in the air exhaust.

14. The wind turbine generating system according to claim 13, further including a Venturi structure in the second wind intake that is positioned to generate the higher speed wind velocity in the air exhaust.

15. The wind turbine generating system according to claim 13, further including flanges attached to the second wind intake and positioned to capture and direct a driving wind through the second wind intake to compress the wind at the Venturi structure.

16. The wind turbine generating system according to claim 13, wherein the wind-catching members are box shaped.

17. The wind turbine generating system according to claim 16 where the inside surfaces of the boxes have a textured coating.

18. A wind capture box for use with a fan blade on a wind generation system, comprising:
a main cavity for receiving wind;
an exit port on the main cavity;
a channel arranged for receiving wind and having a channel exit port, the channel exit port being positioned adjacent to the main cavity exit port;
a Venturi structure in the channel for reducing pressure adjacent the channel exit port;
wherein the reduced pressure at the channel exit port acts to draw an increased amount of air from the main cavity.

19. The wind capture box according to claim 18, further comprising a wind concentrator on the input to the main cavity.

20. The wind capture box according to claim 18, further comprising a wind concentrator on the input to the channel.
